(19) United States
(12) Patent Application Publication
(10) Pub. No.: US 2024/0413565 A1
(43) Pub. Date: Dec. 12, 2024

(54) RELIABLE COMPACT RECEPTACLE CONNECTOR

(71) Applicant: Amphenol East Asia Electronic Technology (Shenzhen) Co., Ltd., Shenzhen (CN)

(72) Inventors: Zhimin Qin, Shenzhen (CN); Fei Wu, Shenzhen (CN)

(73) Assignee: Amphenol East Asia Electronic Technology (Shenzhen) Co., Ltd., Shenzhen (CN)

(21) Appl. No.: 18/738,380

(22) Filed: Jun. 10, 2024

(30) Foreign Application Priority Data
Jun. 12, 2023 (CN) 202310691836.X
Jun. 12, 2023 (CN) 202321495653.2

(51) Int. Cl. H01R 13/502; H01R 13/52; H01R 43/20

(52) U.S. Cl. CPC H01R 13/502; H01R 13/5202; H01R 43/20

(57) ABSTRACT

A reliable, compact receptacle connector including a main shell enclosing a terminal assembly having terminals held by a housing. The housing has a tongue holding terminal mating ends and a rear portion disposed outside the main shell. An outer shell is disposed outside the main shell. The outer shell and the rear portion of the housing have complementary features engaging each other to restrain relative movements in a mating direction. An inner shell conforming to a portion of the housing engages inner surfaces of the main shell. The inner shell and outer shell are welded to the main shell, respectively. A front seal made of an adhesive can be shaped and cured when disposed on a rough portion of the main shell. A rear seal can be disposed in the main shell and join the rear portion of the housing with the housing portion inside the main shell.

### CROSS-REFERENCE TO RELATED APPLICATIONS

This application claims priority to and the benefit of Chinese Patent Application Serial No. 202321495653.2, filed on Jun. 12, 2023. This application also claims priority to and the benefit of Chinese Patent Application Serial No. 202310691836.X, filed on Jun. 12, 2023. The entire contents of these applications are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time. For example, portable electronic devices often include USB Type-C receptacle connectors for various purposes such as charging and/or exchanging data with another electronic device by connecting the USB receptacle connector with a USB plug connector.

Some USB connectors are water resistant. These connectors may include seals that block water from outside the computer enclosure from entering the computer enclosure through the opening left for the connector.

### BRIEF SUMMARY

Aspects of the present application relate to reliable compact receptacle connectors.

Some embodiments relate to a receptacle connector. The receptacle connector may include a terminal assembly comprising a housing and a plurality of conductive elements held by the housing, each of the plurality of conductive elements comprising a mating end, a tail end, and an intermediate portion between the mating end and the tail end; a first shell disposed on a portion of the housing of the terminal assembly and conforming to surfaces of the portion of the housing of the terminal assembly; a second shell surrounding the terminal assembly and extending from the mating ends of the plurality of conductive elements at least to the portion of the housing of terminal assembly; and a weld joining the second shell to the first shell.

Optionally, the first shell and the portion of the housing comprise complementary features configured to engage each other so as to retain the first shell to the portion of the housing.

Optionally, the complementary features comprise an opening of the first shell and a protrusion of the portion of the housing disposed in the opening of the first shell.

Optionally, the complementary features comprise a recess of the portion of the housing and a beam of the first shell extending into the recess of the portion of the housing.

Optionally, the portion of the housing of the terminal assembly is a first portion of the housing of the terminal assembly; the housing of the terminal assembly comprises a second portion disposed outside the second shell; and the receptacle connector comprises a rear seal disposed in the second shell and between the first and second portions of the housing of the terminal assembly.

Optionally, a mating end of the second shell comprises a portion that has a surface roughness higher than that of portions of the first shell; and the receptacle connector comprises a front seal attached to the portion of the mating end of the second shell.

Optionally, the receptacle connector includes a third shell disposed outside the second shell and comprising one or more openings aligned with the weld joining the second shell to the first shell.

Optionally, the weld joining the second shell to the first shell is a first weld; and the connector comprises a second weld joining the third shell to the second shell.

Optionally, the second portion of the housing of the terminal assembly and the third shell comprise complementary features configured to engage each other so as to reduce risk of relative movement therebetween.

Optionally, the complementary features comprise a recess of the third shell and a protrusion of the second portion of the housing of the terminal assembly disposed in the recess of the third shell.

Some embodiments relate to a receptacle connector. The receptacle connector may include a main shell surrounding a cavity and comprising a mating end and a tail end opposite the mating end; a terminal assembly disposed in the cavity, the terminal assembly comprising a housing comprising a tongue, a rear portion disposed outside the main shell and comprising a protrusion, and an intermediate portion between the tongue and the rear portion, and a plurality of conductive elements held by the housing, each of the plurality of conductive elements comprising a mating end extending in a mating direction and held by the tongue of the housing, a tail end extending out of the rear portion of the housing; and an outer shell disposed outside the main shell and comprising a plurality of legs extending in a mounting direction perpendicular to the mating direction and a recess extending opposite to the mounting direction, wherein the protrusion of the rear portion of the housing of the terminal assembly is disposed in the recess of the outer shell.

Optionally, the protrusion of the rear portion of the housing of the terminal assembly is elongated in the mounting direction.

Optionally, the mating end of the main shell extends beyond a mating end of the outer shell and comprises a portion that has a surface roughness higher than that of portions of the main shell; and the receptacle connector comprises a front seal attached to the portion of the mating end of the main shell.

Optionally, for each of the plurality of conductive elements: the tail end comprises a mounting surface extending perpendicular to the mounting direction.

Optionally, the housing of the terminal assembly comprises one or more bars connecting the intermediate portion and the rear portion; and the receptacle connector comprises a rear seal enclosing the one or more bars and portion of the plurality of conductive elements extending between the intermediate portion and the rear portion of the housing of the terminal assembly.

Optionally, the receptacle connector may include an inner shell at least partially enclosing a portion of the intermediate portion of the housing of the terminal assembly, wherein the outer shell comprises one or more openings aligned with the inner shell; and the inner shell is welded to the main shell at locations corresponding to the one or more openings of the outer shell.

Some embodiments relate to a method of manufacturing a receptacle connector. The method may include providing a terminal assembly comprising a plurality of conductive elements held by a housing; disposing a first shell on a portion of the housing of the terminal assembly; inserting the terminal assembly into a second shell until the first shell disposed inside the second shell and engaging inner surfaces of the second shell; and disposing a third shell on the second shell comprising inserting a protrusion of the housing of the terminal assembly into a recess of the third shell.

Optionally, the third shell comprises one or more openings; and the method comprises welding the second shell to the first shell through the one or more openings of the third shell.

Optionally, the method may include welding the third shell to the second shell.

Optionally, disposing the first shell on the portion of the housing of the terminal assembly comprises bending beams of the first shell into respective recesses of the portion of the housing.

Some embodiments relate to a receptacle connector for an electronic device. The receptacle connector may comprise a terminal assembly comprising a plurality of conductive elements and an assembly housing for accommodating the conductive elements, the assembly housing molded over the conductive elements; an inner shell sleeved on at least a portion of an outer side of the assembly housing; a main shell attached to an outer side of the inner shell and the terminal assembly; an outer shell attached to an outer side of the main shell, a mating end of the main shell extending beyond a mating end of the outer shell in a mating direction in which the receptacle connector is connected with a corresponding plug connector; and a first sealing member attached to an outer side wall of the main shell extending beyond the mating end of the outer shell, wherein the assembly housing comprises a first portion connected with the inner shell, the first portion is provided near a tail end of the main shell and comprises a recessed portion, the inner shell comprises a retaining member engaged with the recessed portion, and the retaining member is integrally formed with the inner shell.

Optionally, the inner shell comprises a plurality of retaining members provided on a first side wall and/or on a second side wall of the inner shell, and the first side wall being opposite to the second side wall in a vertical direction perpendicular to the mating direction.

Optionally, the retaining member is formed as a beam comprising a first beam and a second beam provided on the first side wall of the inner shell, the first portion comprises a first recessed portion being mated with the first beam and a second recessed portion being mated with the second beam, and the first recessed portion and the second recessed portion are open towards the inner shell in the vertical direction. In some examples, the first recessed portion and the second recessed portion are provided near the distal edge portion of the first portion.

Optionally, the beam comprises a third beam and a fourth beam provided on the second side wall of the inner shell, the first portion comprises a third recessed portion being mated with the third beam and a fourth recessed portion being mated with the fourth beam, and the third recessed portion and the fourth recessed portion are open towards the inner shell in the vertical direction.

Optionally, a first free end of the first beam and a second free end of the second beam extend towards an inner side of the inner shell and are accommodated in the first recessed portion and the second recessed portion, respectively, in when the inner shell is assembled with the first portion.

Optionally, the first beam and the second beam are mirrored about a plane passing through a vertical center axis of the inner shell along the vertical direction.

Optionally, the inner shell is at least partially attached to a mating side surface of the first portion, a contoured shape of the inner shell is partially adapted to an external contour of the first portion, and at least a portion of an inner circumferential surface of the inner shell is closely fitted to an outer circumferential surface of the first portion.

Optionally, the assembly housing comprises a second portion and an intermediate portion provided between the first portion and the second portion, the second portion, the intermediate portion and the first portion being provided in sequence along the mating direction, and the second portion extending beyond the first portion and the intermediate portion in a horizontal direction perpendicular to the mating direction and the vertical direction.

Optionally, the outer shell comprises a first outer shell side wall provided with a first outer shell engaging portion and a second outer shell side wall provided with a second outer shell engaging portion, the first outer shell side wall being opposite to the second outer shell side wall in the horizontal direction, the second portion comprising a first lateral engaging portion and a second lateral engaging portion opposite to the first lateral engaging portion in the horizontal direction, wherein the first lateral engaging portion engages the first outer shell engaging portion and the second lateral engaging portion engages the second outer shell engaging portion, in an assembled state of the receptacle connector.

Optionally, the first outer shell engaging portion and the second outer shell engaging portion are formed as openings, the first lateral engaging portion and the second lateral engaging portion are formed as protrusions protruding from an outer surface of the second portion and suitable for engagement with the openings, and an inner surface of the openings being at least partially in contact with the protrusions.

Optionally, the protrusion is shaped to have a circular, oval, triangular, square, or irregularly shaped cross-section.

Optionally, the first lateral engaging portion is configured to engage the first outer shell engaging portion in a snap-fitting manner, and the second lateral engaging portion is configured to engage the second outer shell engaging portion in a snap-fitting manner.

Optionally, the receptacle connector comprises a second sealing member provided at the intermediate portion, and an outer circumferential surface of the second sealing member is in contact with a portion of an inner surface of the main shell and forms an interference fit with the portion of an inner surface of the main shell.

Optionally, the plurality of conductive elements of the terminal assembly extend along the mating direction, mating ends of the plurality of conductive elements are arranged in two rows, two rows of the mating ends are arranged substantially parallel to each other along a horizontal direction perpendicular to the mating direction, and tail ends of the plurality of conductive elements opposite to the mating ends are arranged in one row along the horizontal direction.

Optionally, a rough portion is provided on an outer side wall of the mating end of the main shell extending beyond the mating end of the outer shell; and a first sealing member is attached to the rough portion of the main shell, and the rough portion comprises a pattern formed by at least one of a diagonal pattern, a grid pattern, or a predetermined symbol pattern. The part of the outer side wall of the main shell of the receptacle connector, that is provided with the rough portion, has a surface roughness higher than a surface roughness of remaining portions of the main shell, thereby significantly improving an adhesion force between the first sealing member and the rough portion of the main shell, reducing the risk of the first sealing member from falling off. Therefore, a seamless seal can be generated between the receptacle connector and the mounting portion of the electronic device when the receptacle connector is mounted to the mounting portion of the electronic device, so as to reduce the risk of water vapor/dust from entering inside the electronic device.

Optionally, the predetermined symbol pattern comprises at least one of a starlike shape, an H shape, or an X shape.

Optionally, the rough portion has a width in a range of 0.1 mm to 5 mm from the mating edge of the main shell in the mating direction on an outer side wall of a mating end of the main shell extending beyond a mating end of the outer shell.

Optionally, the first sealing member is an elastically deformable member and the first sealing member is configured to elastically deform when the first sealing member is in contact with the mounting portion of the electronic device and to form an interference fit with the mounting portion of the electronic device in a direction perpendicular to the mating direction.

Optionally, the first sealing member is configured to have an annular shape extending circumferentially and continuously around the mating end of the main shell, and the first sealing member is configured to have an attachment surface forming a positive fit (forming a shape and position fitting) with the mating end of the main shell.

Optionally, the first sealing member is provided with a tapering portion tapering along the mating direction towards the mating end of the first sealing member, and an inclined outer surface of the tapering portion forms an angle of 20 degrees to 40 degrees relative to the a mating end surface of the first sealing member.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an exemplary receptacle connector, according to some embodiments.

FIG. 2 is an exploded perspective view of the receptacle connector of FIG. 1, according to some embodiments.

FIG. 3 is a perspective view of a terminal assembly of the receptacle connector of FIG. 1, according to some embodiments.

FIG. 4 is a top view of the terminal assembly of FIG. 3, according to some embodiments.

FIG. 5 is a side schematic view of the terminal assembly of FIG. 3, according to some embodiments.

FIG. 6 is a rear view of the terminal assembly of FIG. 3, according to some embodiments.

FIG. 7 is a perspective view of the terminal assembly of FIG. 3 and an inner shell disposed thereon, according to some embodiments.

FIG. 8 is a side view of the terminal assembly and the inner shell of FIG. 7, according to some embodiments.

FIG. 9 and FIG. 10 are cross-section views of the terminal assembly and the inner shell of FIG. 7, taken along a line marked “E-E” in FIG. 8, according to some embodiments.

FIG. 11 is a perspective view of an outer shell of the receptacle connector of FIG. 1, according to some embodiments.

FIG. 12 is a perspective view of a portion of the terminal assembly of FIG. 3, with a subassembly housing hidden, showing before cutting tie bars connecting conductive elements to strips, according to some embodiments.

FIG. 13 is a schematic perspective view of a main shell of the receptacle connector of FIG. 1, according to some embodiments.

FIG. 14 is a side view of the receptacle connector of FIG. 1, according to some embodiments.

### DETAILED DESCRIPTION

The inventors have recognized and appreciated techniques for making reliable compact receptacle connectors. A receptacle connector may be integrated inside a chassis of an electronic device and configured to receive a mating component such as a plug connector to enable the electronic device to connect with other devices. The force applied to insert a mating component into an existing receptacle connector may cause various issues such as over-insertion and therefore poor or intermittent electrical contact, causing terminal assembly dislocation with respect to a shell. Conventional designs may have an outer shell with portions extending along a rear end of a connector and portions of an assembly housing abutting against the portions of the outer shell to restrain relative movements. Such designs may occupy more space than is desirable for many compact electronic devices.

Techniques described herein enable more compact receptacle connectors while maintaining/improving robustness. Such techniques are illustrated herein as applied to a USB Type-C right-angle receptacle connector. According to aspects of the present disclosure, a connector may include a main shell enclosing a terminal assembly having terminals held by a housing. The housing may have a tongue holding terminal mating ends and a rear portion disposed outside the main shell. An outer shell may be disposed outside the main shell. The outer shell and the rear portion of the housing may have complementary features engaging each other to restrain relative movements in a mating direction. An inner shell conforming to a portion of the housing may engage inner surfaces of the main shell. The inner shell and outer shell may be welded to the main shell, respectively. A front seal made of an adhesive can be shaped and cured when disposed on a portion of the main shell. That portion of the main shell may be roughened to promote adhesion. A rear seal can be disposed in the main shell and join the rear portion of the housing with the housing portion inside the main shell.

According to aspects of the present disclosure, an inner shell may include a retaining member, which may be integrally formed with the inner shell. The retaining member of the inner shell may engage a recessed portion of the accommodating portion of the terminal assembly. When the receptacle connector is mated with a plug connector, the retaining member of the inner shell may engage the recessed portion of the terminal assembly such that the position of the inner shell is fixed with respect to the assembly housing (e.g., insulating plastic core) of the terminal assembly. Such a configuration may prevent the inner shell from shifting with respect to the terminal assembly in the mating direction. Such a configuration may prevent the inner shell from being misaligned or undesirably shifted with respect to the terminal assembly due to frequent insertion and removal of the mating portion of the plug connector. Such a configuration may reduce the number of components of the receptacle connector, and simplify the manufacturing process, enabling a compact structure while also improving the durability of the receptacle connector.

When the receptacle connector and the corresponding plug connector are mated with each other, the mating portion of the plug connector may abut at least partially against the mating side surface of the inner shell. Such a configuration enables controlling the insertion position and the insertion depth of the mating portion of the plug connector by the inner shell, reducing the risk of poor or intermittent electrical contact between the connectors.

The connector may have a front seal. The front seal may be made from an adhesive, which may provide more flexibility in locating the front seal. The adhesive may be disposed on the rough portion and shaped and cured on the rough portion to form the front seal. The front seal may provide improved water resistance. One or more features may be used to provide mechanical integrity to the front seal. In some examples, the mating end of the main shell may have a rough portion. That portion may be processed differently from other portions of the shell such that it has a surface roughness higher than other portions of the shell. Different processing may result from processing steps, preferentially performed on the portion, to roughen the surface. Alternatively or additionally, different processing may result from omitting processing steps that tend to smooth other parts of the shell, such as cold rolling or plating. In some examples, a desired surface roughness for the rough portion may be obtained by using Electrical Discharge Machining (EDM). It should be appreciated that larger EDM may lead to higher roughness and better adhesion. In some examples, the rough portion may have patterns to enhance adhesion. These patterns may be visually observable and/or comprise symbols such as *, H, or X, which may be laser imprinted around the mating end of the shell. In some examples, the rough portion may extend in the mating direction by a distance in a range of 0.1 mm to 5 mm such as in a range of 0.5 mm to 1.5 mm.

A front seal may be disposed on the rough portion of the mating end of the main shell such that the front seal can be securely attached to the main shell. In some examples, an adhesive (e.g., UV glue, silicone, epoxy glue, or underfill) may be disposed on the rough portion and shaped and cured on the rough portion to form the front seal. The front seal can be spaced from the outer shell in the mating direction so as to extend above the outer shell. Such a configuration enables the front seal to deform in a direction perpendicular to the mating direction when the connector is pressed, in the mating direction, against a wall with an opening through which the mating face of the connector will be exposed, blocking ingress of environmental contaminants. The front seal may also block any path between the mating ends of the inner and outer shells.

Alternatively or additionally, the shell to which the shield is affixed may have a lip forming a corner between the lip and a surface of the shell. The front seal may be affixed in this corner. A surface of either or both of the lip or shell in the corner may be roughened for improved adhesion of the front scal.

A rear seal can be disposed in the main shell and join the rear portion of the housing with the housing portion inside the main shell. By providing the rear seal, a tight seal between the terminal assembly and the main shell may be achieved, further reducing the risk of water or dust entering through the socket of the receptacle connector into the electronic device.

Next, exemplary embodiments of the receptacle connector according to the present application will be described in detail with reference to the accompanying drawings. For a clear and concise description, a mating direction Y, a horizontal direction X and a vertical direction Z may be shown in the figures. The mating direction Y, the horizontal direction X and the vertical direction Z may be perpendicular to one another. The mating direction Y may refer to a direction in which the receptacle connector is to connect with a corresponding plug connector. The horizontal direction X may refer to a width direction of the receptacle connector. The vertical direction Z may refer to a height direction of the receptacle connector.

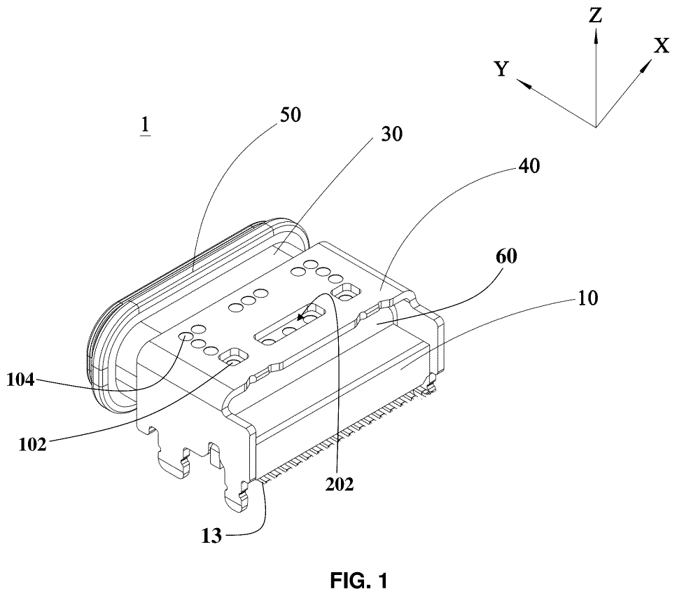

As shown in FIGS. 1-3, a receptacle connector 1 for an electronic device may include a terminal assembly 10 comprising a plurality of conductive elements 13 and an assembly housing 11 holding the conductive elements 13. As can be seen in the figures, each conductive element 13 may include a mating end 304, a tail end 306, and an intermediate portion between the mating end 304 and the tail end 306. The assembly housing 11 may be molded over the conductive elements 13. As can be seen in the figures, the assembly housing 11 may include a tongue 302, a rear portion 120 disposed outside a cavity 208 of a main shell 30, and an intermediate portion between the tongue 302 and the rear portion 120.

An inner shell 20 may be sleeved on at least a portion of an outer side of the assembly housing 11. The main shell 30 may be attached to an outer side of the inner shell 20 and the terminal assembly 10. An outer shell 40 may be attached to an outer side of the main shell 30. As can be seen in the figures, the outer shell 40 may have openings 220 aligned with a region of the main shell 30 that is welded to the inner shell 20 at locations 102. The outer shell 40 may also be welded to the main shell at locations 104. The outer shell 40 may have legs 212 extending in a mounting direction (e.g., Z direction) perpendicular to the mating direction and configured to be inserted into receivers (e.g., holes) of a circuit board. In the illustrated example, the tail end 306 includes a mounting surface 214 extending perpendicular to the mounting direction and configured to surface mount to the circuit board.

A mating end 204 of the main shell 30 may extend beyond a mating end 210 of the outer shell 40 in a mating direction Y in which the receptacle connector is to mate with a plug connector. A first sealing member 50 may be attached to an outer side wall of the main shell 30 that extends beyond the mating end of the outer shell 40.

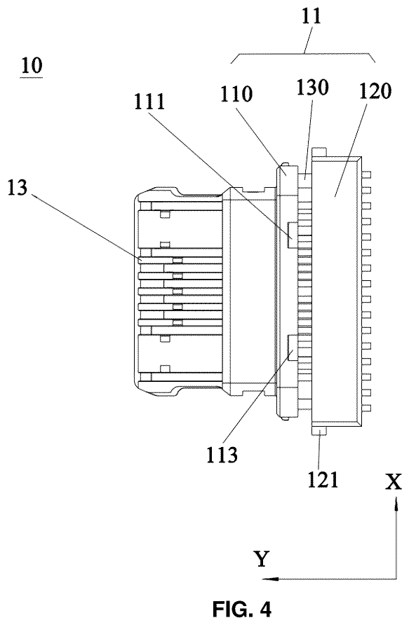

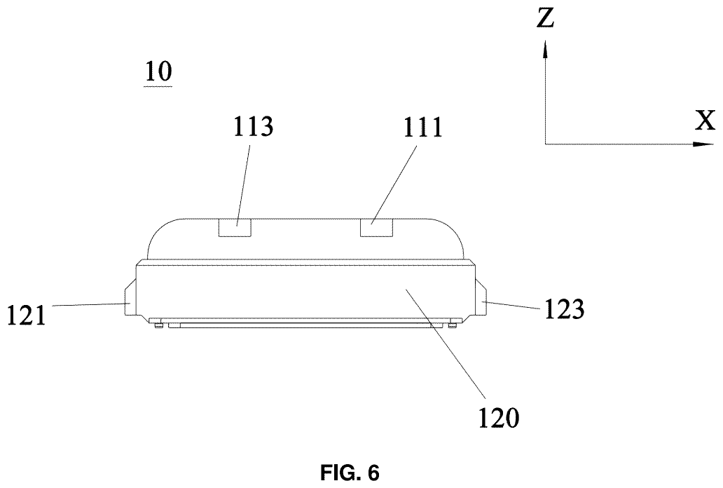

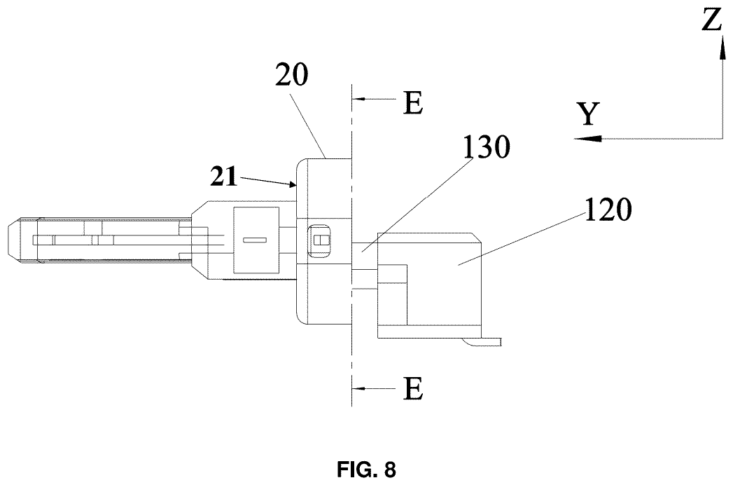

Also referring to FIGS. 4-8, the assembly housing 11 may include a first portion 110 connected with the inner shell 20. The inner shell 20 and the assembly housing 11 may include complementary features configured to engage each other so as to retain the inner shell 20 to the assembly housing 11. As illustrated, the first portion 110 may be disposed near a tail end 206 of the main shell 30 and include a recessed portion 111. The inner shell 20 may include a retaining member (e.g., beam 24) engaging the recessed portion 111 of the first portion 110 of the assembly housing 11. The retaining member may be integrally formed with the inner shell 20. As can be seen in the figures, the inner shell 20 may include an opening 702 and the first portion 111 may include a protrusion 704 disposed in the opening 702. It should be appreciated that although beams 24 and recessed portions 111 and protrusions 704 and openings 702 are shown in the illustrated example, the assembly housing 11 and inner shell 20 may have any suitable complementary features. The present disclosure is not intended to be limited to this aspect.

When the receptacle connector is mated with a plug connector, the mating portion of the plug connector is in contact with a surface of a mating end of the inner shell 20, and a position of the mating portion of the plug connector is limited by a mating end surface 21 of the inner shell 20, thus enabling control of an insertion depth of the mating portion and avoiding an over-insertion or insufficient insertion. The retaining member of the inner shell 20 engages the first portion 110 of the assembly housing 11 (e.g., insulating plastic core) of the terminal assembly 10 such that the inner shell 20 is fixed with respect to the assembly housing 11 of the terminal assembly 10, thereby effectively reducing the risk of the inner shell from shifting with respect to the terminal assembly along the mating direction Y. In addition, since the inner shell according to the present application comprises a retaining member integrally formed with the inner shell, for example, the retaining member is part of the inner shell, no additional fixing components for attaching the inner shell to the terminal assembly are required. Such a configuration reduces the number of components of the receptacle connector, and simplifies the manufacturing process, enabling a compact structure while also improving the durability of the receptacle connector. Thus, the contact stability and the connection reliability between the plug connector and the receptacle connector are improved.

In addition, by providing the first sealing member 50, a seal is formed between the main shell and the mounting portion of the electronic device, reducing the risk of water or dust entering from the socket of the USB Type-C receptacle connector from entering inside the electronic device, avoiding a short circuit inside the electronic device, and improving safety performance.

In some exemplary embodiments, the retaining member may be bent toward the inner side of the inner shell 20 in the assembled state of the receptacle connector, so as to engage the recessed portion of the first portion. In some examples, the inner shell can be bendable and deformable. For example, the inner shell may be made of metal.

In some exemplary embodiments, the inner shell 20 comprises a plurality of retaining members provided on a first side wall 23 and/or on a second side wall 25 of the inner shell 20, the first side wall 23 being opposite to the second side wall 25 in a vertical direction Z perpendicular to the mating direction Y.

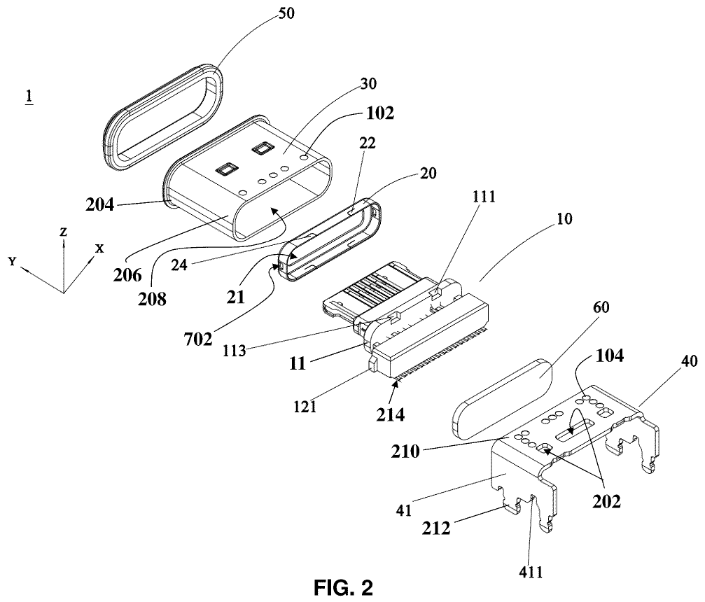

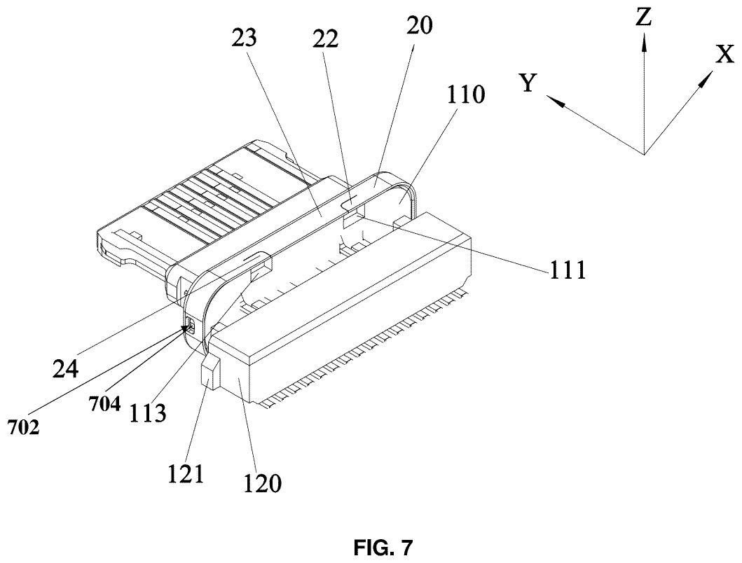

In some exemplary embodiments, the retaining member is formed as a beam. For example, the beam is a sheet member cut from the inner shell 20. Optionally, the slits forming the beam are cut from the distal edge of the inner shell 20. As shown in FIG. 2 and FIG. 7, the beam comprises a first beam 22 and a second beam 24 provided on the first side wall 23 of the inner shell 20. The first portion 110 comprises a first recessed portion 111 being mated with the first beam 22 and a second recessed portion 113 being mated with the second beam 24, and the first recessed portion 111 and the second recessed portion 113 are open towards the inner shell 20 in the vertical direction Z. In some examples, the first recessed portion 111 and the second recessed portion 113 are provided near the distal edge portion of the first portion 110.

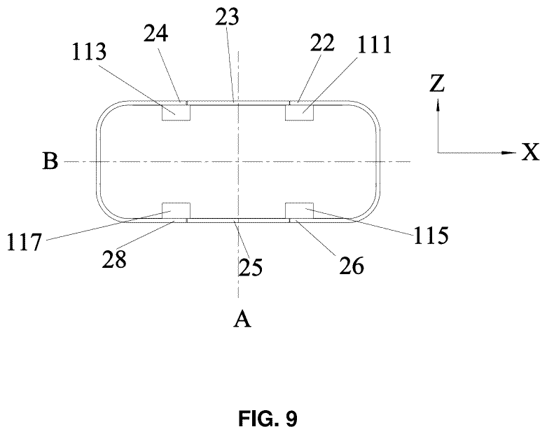

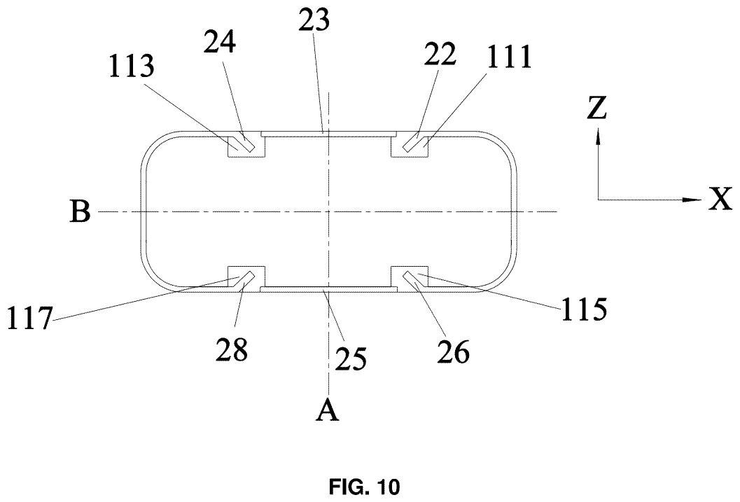

In some exemplary embodiments, as shown in FIG. 9 and FIG. 10, FIG. 9 illustrates a cross-section view of the inner shell 20 of the first portion 110 when not assembled, and FIG. 10 illustrates a cross-section view of the inner shell 20 of the first portion 110 when assembled. The beam comprises a third beam 26 and a fourth beam 28 provided on the second side wall 25 of the inner shell 20, the first portion 110 comprises a third recessed portion 115 being mated with the third beam 26 and a fourth recessed portion 117 being mated with the fourth beam 28, and the third recessed portion 113 and the fourth recessed portion 117 are open towards the inner shell 20 in the vertical direction Z.

In some embodiments, as shown in FIG. 10, the first beam 22 and the second beam 24 provided on the first side wall 23 are mirrored with respect to the third beam 26 and the fourth beam 28 provided on the second side wall 25 about a plane passing through a horizontal center axis B of the inner shell 20 along the horizontal direction X.

When the inner shell 20 is assembled with the first portion 110, a first free end of the first beam 22 and a second free end of the second beam 24 extend towards an inner side of the inner shell 20 and are accommodated in the first recessed portion 111 and the second recessed portion 113, respectively. In some examples, the first free end of the first beam 22 and the second free end of the second beam 24 are opposite to each other in the horizontal direction X. The length of the first beam 22 in the horizontal direction is provided to be smaller than the length of the first recessed portion 111 in the horizontal direction, and the length of the second beam 24 in the horizontal direction is provided to be smaller than the length of the second recessed portion 113 in the horizontal direction.

In some examples, the size of the first beam 22 in the mating direction Y is configured to be smaller than the size of the inner shell 20 in the mating direction Y. Optionally, the size of the first beam 22 in the mating direction Y is half the size of the inner shell 20 in the mating direction Y.

In some exemplary embodiments, as shown in FIG. 10, the first beam 22 and the second beam 24 are mirrored about a plane passing through a vertical center axis A of the inner shell 20 along the vertical direction Z. It should be understood that the number, the size, the location and the arrangement mode of the beam and the recessed portion are not limited to the specific embodiment shown, and can be adjusted as actually needed.

In some exemplary embodiments, as shown in FIG. 2 and FIG. 7, the inner shell 20 is at least partially attached to a mating side surface of the first portion 110, a contoured shape of the inner shell 20 is partially adapted to an external contour of the first portion 110, and at least a portion of an inner circumferential surface of the inner shell 20 is closely fitted to an outer circumferential surface of the first portion 110.

When the receptacle connector is mated with a plug connector, the mating portion of the plug connector is abutted at least partially against the mating side surface of the inner shell to limit the mating portion of the plug connector, such that the over-insertion of the mating portion of the plug connector is effectively avoided.

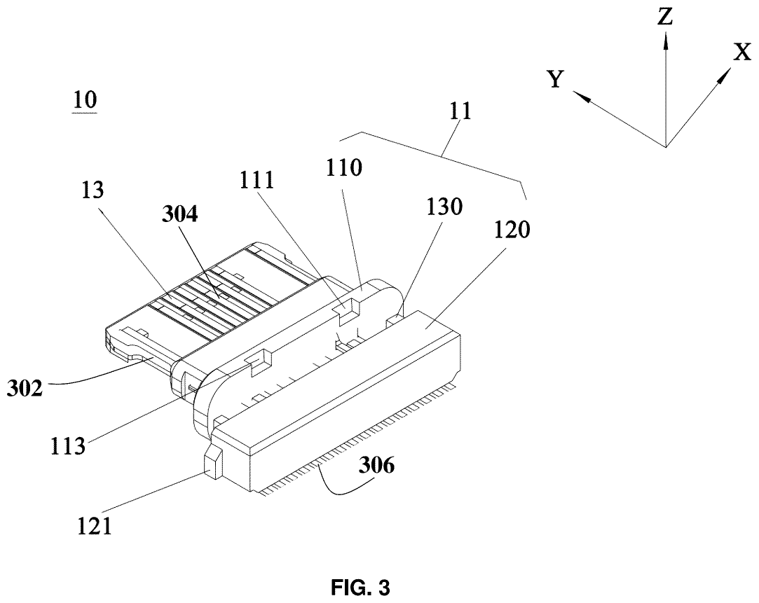

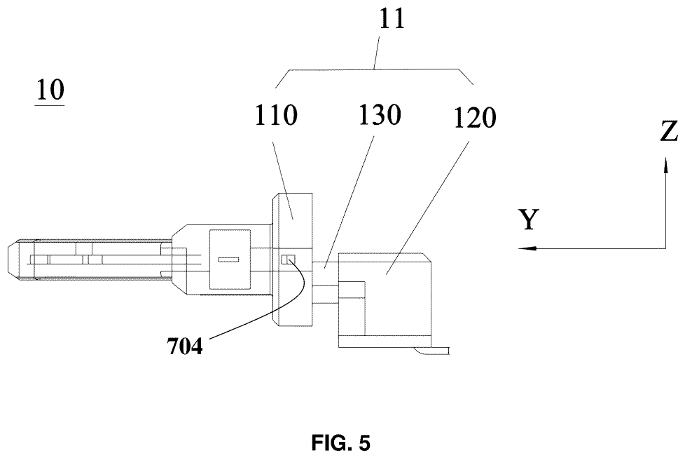

As shown in FIG. 3 and FIG. 5, in one exemplary embodiment, the assembly housing 11 comprises a second portion 120 and an intermediate portion 130 provided between the first portion 110 and the second portion 120. The second portion 120, the intermediate portion 130 and the first portion 110 are disposed along the mating direction Y, and the second portion 120 extends beyond the first portion 110 and the intermediate portion 130 in a horizontal direction X perpendicular to the mating direction Y and the vertical direction Z.

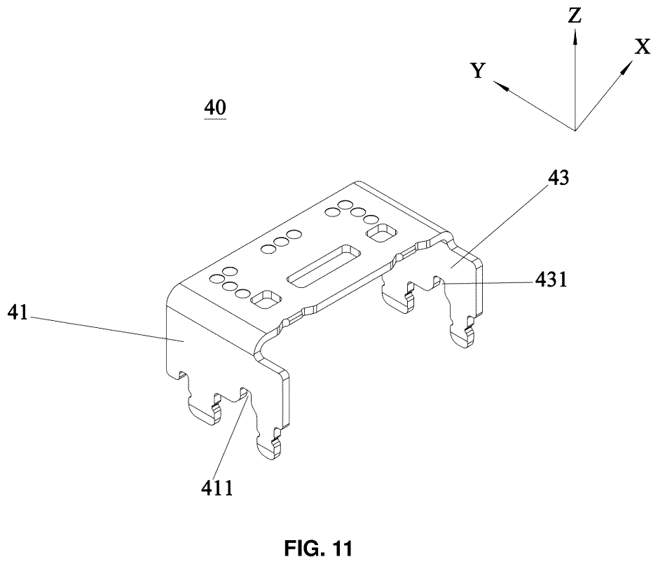

In some exemplary embodiments, as shown in FIG. 2 and FIG. 11, the outer shell 40 comprises a first outer shell side wall 41 provided with a first outer shell engaging portion 411 and a second outer shell side wall 43 provided with a second outer shell engaging portion 431. The first outer shell side wall 41 is opposite to the second outer shell side wall 43 in the horizontal direction X, and the second portion 120 comprises a first lateral engaging portion 121 and a second lateral engaging portion 123 opposite to the first lateral engaging portion 121 in the horizontal direction X. The first lateral engaging portion 121 is configured to engage the first outer shell engaging portion 411 and the second lateral engaging portion 123 is configured to engage the second outer shell engaging portion 431.

With this configuration, the position of the outer shell 40 relative to the second portion 120 of the assembly housing 11 is limited such that the outer shell 40 is fixed in place relative to the terminal assembly 10, thereby preventing the outer shell 40 from wobbling or undesired displacement relative to the terminal assembly 10.

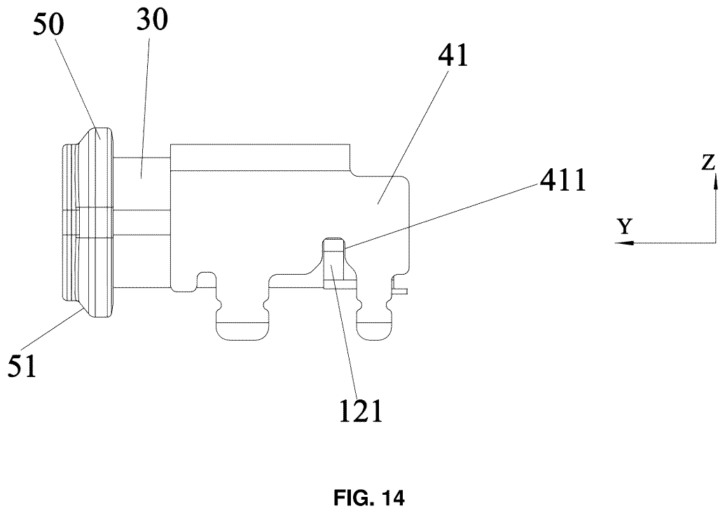

In some exemplary embodiments, as shown in FIG. 11 and FIG. 14, the first outer shell engaging portion 411 and the second outer shell engaging portion 431 are formed as openings. The first lateral engaging portion 121 and the second lateral engaging portion 123 are formed as protrusions protruding from an outer surface of the second portion 120 and suitable for engagement with the opening. An inner surface of the opening is at least partially in contact with the protrusions. In some examples, the protrusion protrudes from an outer surface of the second portion 120 along the horizontal direction X, and the two lateral surfaces of the protrusion perpendicular to the mating direction Y are in contact with the corresponding inner surfaces of the opening.

In some exemplary embodiments, the protrusions forming the first lateral engaging portion 121 and the second lateral engaging portion 123 may be shaped to have a circular, oval, triangular, square, or irregularly shaped cross-section. It should be understood that the number, the shape, and the arrangement mode of the protrusions are not limited thereto, and can be adjusted upon actual requirements.

In some other exemplary embodiments, the first lateral engaging portion 121 may be configured to engage the first outer shell engaging portion 411 in a snap-fitting manner, and the second lateral engaging portion 123 may be configured to engage the second outer shell engaging portion 431 in a snap-fitting manner, such that the outer shell 40 is fixed in place relative to the terminal assembly 10.

In some embodiments, the receptacle connector 1 comprises a second sealing member 60 provided at the intermediate portion 130, an outer circumferential surface of the second sealing member 60 is in contact with a portion of an inner surface of the main shell 30 and forms an interference fit with the portion of the inner surface of the main shell 30. In one example, the second sealing member 60 is made of plastic or synthetic resin. For example, the second sealing member 60 is an epoxy resin sealing member.

With this configuration, the position of the main shell 30 of the receptacle connector 1 is limited relative to the terminal assembly 10, and a waterproof seal is formed between the main shell 30 and the terminal assembly 10, reducing the risk of water or dust entering from the socket of the USB Type-C receptacle connector from entering inside the electronic device. By providing the first sealing member 50 and the second sealing member 60, the technical solution of the present application achieves double sealing of the receptacle connector and improves the waterproof performance.

In an example, the second sealing member 60 is provided between the first portion 110 and the second portion 120. Both an outer circumferential contour portion of the second scaling member 60 and an outer circumferential contour portion of the inner shell 20 attached to the first portion 110 are provided to adapt to an inner circumferential contour portion of the main shell 30. The outer circumferential contour portion of the second sealing member 60 is closely fitted to the inner circumferential contour portion of the main shell 30.

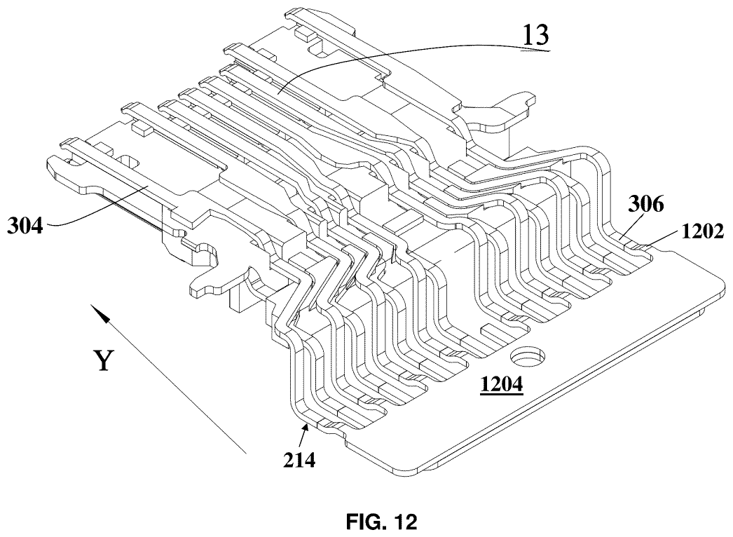

In some embodiments, as shown in FIG. 12, the plurality of conductive elements 13 of the terminal assembly 10 extend along the mating direction Y, mating ends 304 of the plurality of conductive elements 13 are arranged in two rows, and two rows of the mating ends 304 are arranged substantially parallel to each other along a horizontal direction X perpendicular to the mating direction Y. The tail ends 306 of the plurality of conductive elements 13 opposite to the mating ends 304 are arranged in one row along the horizontal direction X. As can be seen in the figures, during manufacturing, the tail ends 306 of the conductive elements 13 in a same row may be connected to a strip 1204 by tie bars 1202. The tail ends 306 are separated from each other when the tie bars 1202 are cut.

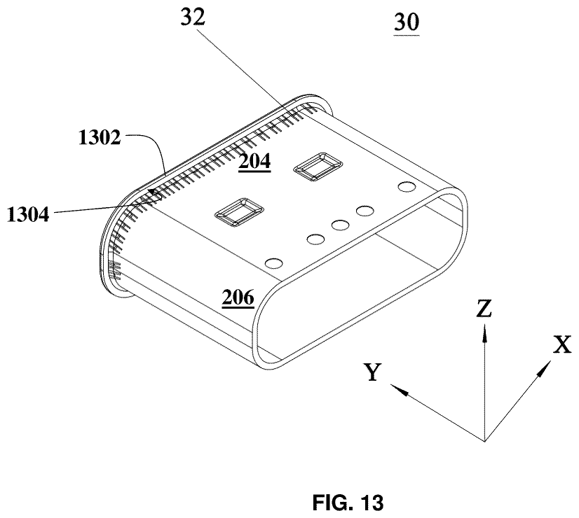

As shown in FIG. 13, the mating end 204 of the main shell 30 may include a flange portion 1302 at a distal end and extending around the main shell 30 to form a corner 1304 with the rough portion 32. The sealing member 50 may be disposed in the corner 1304. The sealing member 50 may block any path between the main shell 50 and the outer shell 40.

A rough portion 32 may be provided on an outer side wall of the mating end 204 of the main shell 30 that extends beyond the mating end of the outer shell 40; and a first sealing member 50 is attached to the rough portion 32 of the main shell 30, and the rough portion 32 comprises a pattern formed by at least one of a diagonal pattern, a grid pattern, or a predetermined symbol pattern.

With the electronic connector according to an exemplary embodiment of the present disclosure, a rough portion is provided on an outer side wall of the mating end of the main shell extending beyond the mating end of the outer shell; and a first sealing member is provided on the rough portion of the main shell. With such a technical solution, a very close attachment between the first sealing member and the main shell can be provided, and the outer side wall of the main shell of the receptacle connector provided with the rough portion has a surface roughness higher than a surface roughness of remaining portions of the main shell, thereby significantly improving an adhesion force between the first sealing member 50 and the rough portion 32 of the main shell 30, reducing the risk of the first sealing member 50 from falling off. Therefore, a seamless seal can be generated between the receptacle connector and the mounting portion of the electronic device when the receptacle connector 1 is mounted to the mounting portion of the electronic device, so as to reduce the risk of water vapor/dust from entering inside the electronic device.

In some exemplary embodiments, the rough portion 32 has a width in a range of 0.1 mm to 5 mm from the mating edge of the main shell 30 in the mating direction on the outer side wall of the main shell 30. In some optional embodiments, the rough portion 32 has a width in a range of 0.5 mm to 3 mm from the mating edge of the main shell 30 in the mating direction Y on the outer side wall of the main shell 30. In some optional embodiments, the rough portion 32 has a width in a range of 0.5 mm to 1.5 mm from the mating edge of the main shell 30 in the mating direction Y on the outer side wall of the main shell 30.

In some exemplary embodiments according to the present application, a surface roughness of the rough portion 32 of the main shell 30 may be in the range of EDM 8-12.

The first sealing member 50 is an elastically deformable member and the first sealing member 50 is configured to elastically deform when the first sealing member 50 contacts the mounting portion of the electronic device and to form an interference fit with the mounting portion of the electronic device in a direction perpendicular to the mating direction. In one example, the first sealing member 50 may be made of ultraviolet light-curable adhesive (UV adhesive), silicone, or epoxy resin adhesive. Ultraviolet light-curable adhesive is rapidly cured into an elastic adhesive film under UV light irradiation, and is characterized by high adhesive strength, vibration resistance, high temperature resistance, and good durability, etc.

The first sealing member 50 has a width in the range of 0.1 mm to 5 mm in the mating direction Y. In some optional embodiments according to the present application, the first sealing member 50 may have a width of 0.95 mm in the mating direction Y. Preferably, the first sealing member 50 may have a width of 1.0 mm in the mating direction Y.

In an exemplary embodiment, as shown in FIG. 14, the first sealing member 50 is configured to have an annular shape extending circumferentially and continuously around the mating end of the main shell 30, and the first sealing member 50 is configured to have an attachment surface forming a positive fit (a shape and position-fitting) with the mating end of the main shell 30. The first sealing member 50 may be provided with a tapering portion 51 tapering along the mating direction towards the mating end thereof, and an inclined outer surface of the tapering portion 51 forms an angle of 20 degrees to 40 degrees relative to a mating end surface of the first sealing member 50.

It should be understood that the term “a positive fit” used in the present application may refer to a relationship in which two mating components are abutting against and tightly fit with each other in terms of the shape and the position.

The present application further provides a method of manufacturing a receptacle connector for an electronic device, comprising: providing a terminal assembly 10 comprising a plurality of conductive elements 13 and an assembly housing 11 for accommodating the conductive elements 13, the assembly housing 11 molded over the conductive elements 13; providing an inner shell 20 sleeved on at least a portion of an outer side of the assembly housing 11; providing a main shell 30 attached to an outer side of the inner shell 20 and the terminal assembly 10; providing an outer shell 40 attached to an outer side of the main shell 30, such that a mating end 204 of the main shell 30 extends beyond a mating end of the outer shell 40 in a mating direction in which the receptacle connector is connected with a corresponding plug connector; and applying an adhesive along a circumferential direction of the main shell 30 at an outer side wall of the mating end of the main shell 30 extending beyond the mating end of the outer shell 40, and curing the adhesive to form a first sealing member 50 attached to the outer side wall.

Providing the terminal assembly 10 may include configuring the assembly housing 11 to comprise a first portion 110 connected with the inner shell 20, the first portion 110 being provided near a tail end of the main shell 30 and comprising a recessed portion, and providing the inner shell may include configuring the inner shell 20 to comprise a retaining member engaging the recessed portion, the retaining member integrally formed with the inner shell 20.

In some exemplary embodiments, providing the inner shell 20 may include configuring the inner shell 20 to comprise a plurality of retaining members, and providing the retaining members on a first side wall 23 and/or on a second side wall 25 of the inner shell 20. The first side wall 23 is opposite to the second side wall 25 in a vertical direction Z perpendicular to the mating direction Y.

In some exemplary embodiments, providing the inner shell 20 may include forming the retaining member as a beam comprising a first beam 22 and a second beam 24 provided on the first side wall 23 of the inner shell 20, and providing the terminal assembly 10 may include configuring the first portion 110 to comprise a first recessed portion 111 being mated with the first beam 22 and a second recessed portion 113 being mated with the second beam 24. The first beam 22 and the second beam 24 extend along the first side wall 23 of the inner shell 20 where the inner shell 20 is not assembled with the first portion 110; and a first free end of the first beam 22 and a second free end of the second beam 24 are bent towards an inner side of the inner shell 20 and are accommodated in the first recessed portion 111 and the second recessed portion 113, respectively, where the inner shell 20 is assembled with the first portion 110.

In some examples, the beams are formed by cutting a prefabricated member of the inner shell 20. For example, the prefabricated member of the inner shell 20 comprises a first side wall 23, a second side wall 25 opposite to the first side wall 23 in the vertical direction Z, and a surface of a mating end. A slit (e.g., a gap) is formed by cutting from the tail end edge of the first side wall 23 so as to form the first beam 22 and the second beam 24. For example, the slit forming the first beam 22 comprises a first slit portion extending in a direction substantially parallel to the mating direction Y from the tail end edge of the inner shell 20 and a second slit portion substantially parallel to the horizontal direction X, and the size of the first slit portion is smaller than the size of the inner shell 20 in the mating direction. Similarly, a slit may be cut starting from the tail end edge of the second side wall 25 to form the third beam 26 and the fourth beam 28.

In some exemplary embodiments, providing the terminal assembly 10 may include configuring the assembly housing 11 to comprise a second portion 120 and an intermediate portion 130 provided between the first portion 110 and the second portion 120. The second portion 120, the intermediate portion 130 and the first portion 110 are provided in sequence along the mating direction Y, and the second portion 120 extends beyond the first portion 110 and the intermediate portion 130 in a horizontal direction X perpendicular to both the mating direction Y and the vertical direction Z. The method of manufacturing the receptacle connector further comprises providing a second sealing member 60. The second sealing member 60 is provided at the intermediate portion 130, that is, the second sealing member 60 is provided between the first portion 110 and the second portion 120, and an outer circumferential surface of the second sealing member 60 is in contact with a portion of an inner surface of the main shell 30 and forming an interference fit with the main shell 30.

In some exemplary embodiments, providing the main shell 30 may include roughening a portion of an outer surface of the main shell 30 near its mating end by laser engraving processing or electrical discharge processing to form a rough portion 32; or embossing or knurling a portion of the outer surface of the main shell 30 near its mating end to form the rough portion 32.

It should be understood that other processing methods can also be used to increase the surface roughness of corresponding portions of the outer surface of the main shell 30. For example, the surface of the main shell 30 can be processed by using tools such as grinding wheels, cutting tools, etc., to obtain the desired roughness.

In some exemplary embodiments, the method may further include providing an adhesive forming tool that is matched with the first sealing member 50 in terms of a predetermined size and shape; placing a rough portion 32 of the mating end of the main shell 30 to be processed in the adhesive forming tool, and applying an adhesive at the rough portion in a circumferential direction along the main shell, wherein the adhesive is applied in the adhesive forming tool by one of the following: time and pressure type dispensing, piston pump dispensing, and screw metering pump dispensing.

In some exemplary embodiments, an adhesive is received in the adhesive forming tool, and may be selected from one of the following: UV adhesive, silicone, epoxy resin adhesive. In some examples, the adhesive used to form the first sealing member 50 may be underfill.

In some exemplary embodiments, providing the outer shell 40 may include forming a first outer shell engaging portion 411 on a first outer shell side wall 41 of the outer shell 40 and forming a second outer shell engaging portion 431 on a second outer shell side wall 43 of the outer shell 40, the first outer shell side wall 41 being opposite to the second outer shell side wall 43 in the horizontal direction X perpendicular to the mating direction Y. Providing the terminal assembly 10 may include configuring the assembly housing 11 to comprise a second portion 120 and configuring the second portion 120 to comprise a first lateral engaging portion 131 and a second lateral engaging portion 133 opposite to the first lateral engaging portion 131 in the horizontal direction X. When the receptacle connector is assembled, the first lateral engaging portion 131 engages the first outer shell engaging portion 411, and the second lateral engaging portion 133 engages the second outer shell engaging portion 431.

In one example, the outer shell 40 may be formed by stamping process. It should be understood that stamping process is a production technology that, with the help of stamping equipment (presses) and tools (dies), pressure is exerted on panel metal or non-metal to allow the panel metal or non-metal to have separation or plastic deformation, thus obtaining a product with a certain shape, size and performance requirements.

Various aspects are described in this disclosure, which include, but are not limited to, the following aspects:

1. A receptacle connector (e.g., 1) for an electronic device, comprising: a terminal assembly (e.g., 10) comprising a plurality of conductive elements (e.g., 13) and an assembly housing (e.g., 11) for holding the conductive elements (e.g., 13), the assembly housing (e.g., 11) molded over the conductive elements; an inner shell (e.g., 20) sleeved on at least a portion of an outer side of the assembly housing (e.g., 11); a main shell (e.g., 30) attached to an outer side of the inner shell (e.g., 20) and the terminal assembly (e.g., 10); an outer shell (e.g., 40) attached to an outer side of the main shell (e.g., 30), a mating end of the main shell (e.g., 30) extending beyond a mating end of the outer shell (e.g., 40) in a mating direction (e.g., Y) in which the receptacle connector is connected with a corresponding plug connector; and a first scaling member (e.g., 50) attached to an outer side wall of the main shell (e.g., 30) extending beyond the mating end of the outer shell (e.g., 40), wherein the assembly housing (e.g., 11) comprises a first portion (e.g., 110) connected with the inner shell (e.g., 20), the first portion (e.g., 110) is provided near a tail end of the main shell (e.g., 30) and comprises a recessed portion, the inner shell (e.g., 20) comprises a retaining member engaging the recessed portion, and the retaining member is integrally formed with the inner shell (e.g., 20).

2. The receptacle connector according to aspect 1 or any other aspect, wherein the inner shell (e.g., 20) comprises a plurality of retaining members provided on a first side wall (e.g., 23) and/or on a second side wall (e.g., 25) of the inner shell (e.g., 20), and the first side wall (e.g., 23) is opposite to the second side wall (e.g., 25) in a vertical direction (e.g., Z) perpendicular to the mating direction (e.g., Y).

3. The receptacle connector according to aspect 2 or any other aspect, wherein the retaining member is formed as a beam comprising a first beam (e.g., 22) and a second beam (e.g., 24) provided on the first side wall (e.g., 23) of the inner shell (e.g., 20), the first portion (e.g., 110) comprises a first recessed portion (e.g., 111) being mated with the first beam (e.g., 22) and a second recessed portion (e.g., 113) being mated with the second beam (e.g., 24), and the first recessed portion (e.g., 111) and the second recessed portion (e.g., 113) are open towards the inner shell (e.g., 20) in the vertical direction (e.g., Z).

4. The receptacle connector according to aspect 3 or any other aspect, wherein the beam comprises a third beam (e.g., 26) and a fourth beam (e.g., 28) provided on the second side wall (e.g., 25) of the inner shell (e.g., 20), the first portion (e.g., 110) comprises a third recessed portion (e.g., 115) being mated with the third beam (e.g., 26) and a fourth recessed portion (e.g., 117) being mated with the fourth beam (e.g., 28), and the third recessed portion (e.g., 113) and the fourth recessed portion (e.g., 117) are open towards the inner shell (e.g., 20) in the vertical direction (e.g., Z).

5. The receptacle connector according to aspect 3 or any other aspect, wherein a first free end of the first beam (e.g., 22) and a second free end of the second beam (e.g., 24) extend towards an inner side of the inner shell (e.g., 20) and are accommodated in the first recessed portion (e.g., 111) and the second recessed portion (e.g., 113), respectively, where the inner shell (e.g., 20) is assembled with the first portion (e.g., 110).

6. The receptacle connector according to aspect 5 or any other aspect, wherein the first beam (e.g., 22) and the second beam (e.g., 24) are mirrored about a plane passing through a vertical center axis (e.g., A) of the inner shell (e.g., 20) along the vertical direction.

7. The receptacle connector according to any one of aspects 1 to 6 or any other aspect, wherein the inner shell (e.g., 20) is at least partially attached to a mating side surface of the first portion (e.g., 110), a contoured shape of the inner shell (e.g., 20) is partially adapted to an external contour of the first portion (e.g., 110), and at least a portion of an inner circumferential surface of the inner shell (e.g., 20) is closely fitted to an outer circumferential surface of the first portion (e.g., 110).

8. The receptacle connector according to any one of aspects 1 to 6 or any other aspect, wherein the assembly housing (e.g., 11) comprises a second portion (e.g., 120) and an intermediate portion (e.g., 130) provided between the first portion (e.g., 110) and the second portion (e.g., 120), wherein the second portion (e.g., 120), the intermediate portion (e.g., 130) and the first portion (e.g., 110) are provided in sequence along the mating direction (e.g., Y), and the second portion (e.g., 120) extends beyond the first portion (e.g., 110) and the intermediate portion (e.g., 130) in a horizontal direction (e.g., X) perpendicular to both the mating direction (e.g., Y) and the vertical direction (e.g., Z).

9. The receptacle connector according to aspect 8 or any other aspect, wherein the outer shell (e.g., 40) comprises a first outer shell side wall (e.g., 41) provided with a first outer shell engaging portion (e.g., 411) and a second outer shell side wall (e.g., 43) provided with a second outer shell engaging portion (e.g., 431), the first outer shell side wall (e.g., 41) is opposite to the second outer shell side wall (e.g., 43) in the horizontal direction (e.g., X), the second portion (e.g., 120) comprises a first lateral engaging portion (e.g., 121) and a second lateral engaging portion (e.g., 123) opposite to the first lateral engaging portion (e.g., 121) in the horizontal direction (e.g., X), wherein the first lateral engaging portion (e.g., 121) engages the first outer shell engaging portion (e.g., 411) and the second lateral engaging portion (e.g., 123) engages the second outer shell engaging portion (e.g., 431), in an assembled state of the receptacle connector.

10. The receptacle connector according to aspect 9 or any other aspect, wherein the first outer shell engaging portion (e.g., 411) and the second outer shell engaging portion (e.g., 431) are formed as openings, the first lateral engaging portion (e.g., 121) and the second lateral engaging portion (e.g., 123) are formed as protrusions protruding from an outer surface of the second portion and suitable for engagement with the openings, and an inner surface of the opening is at least partially in contact with the respective protrusion.

11. The receptacle connector according to aspect 10 or any other aspect, wherein the protrusions are shaped to have a circular, oval, triangular, square, or irregularly shaped cross-section.

12. The receptacle connector according to aspect 9 or any other aspect, wherein the first lateral engaging portion (e.g., 121) is configured to engage the first outer shell's engaging portion (e.g., 411) in a snap-fitting manner, and the second lateral's engaging portion (e.g., 123) is configured to engage the second outer shell engaging portion (e.g., 431) in a snap-fitting manner.

13. The receptacle connector according to aspect 8 or any other aspect, wherein the receptacle connector (e.g., 1) comprises a second sealing member (e.g., 60) provided at the intermediate portion (e.g., 130), and an outer circumferential surface of the second sealing member (e.g., 60) is in contact with a portion of an inner surface of the main shell (e.g., 30) and forms an interference fit with the main shell (e.g., 30).

14. The receptacle connector according to any one of aspects 1 to 6 or any other aspect, wherein the plurality of conductive elements of the terminal assembly (e.g., 10) extend along the mating direction (e.g., Y), mating ends of the plurality of conductive elements are arranged in two rows, two rows of the mating ends are arranged substantially parallel to each other along a horizontal direction (e.g., X) perpendicular to the mating direction (e.g., Y), and tail ends of the plurality of conductive elements opposite to the mating ends are arranged in one row along the horizontal direction (e.g., X).

15. The receptacle connector according to any one of aspects 1 to 6 or any other aspect, wherein a rough portion (e.g., 32) is provided on an outer side wall of a mating end of the main shell (e.g., 30) extending beyond a mating end of the outer shell (e.g., 40); and the first sealing member (e.g., 50) is attached to the rough portion (e.g., 32) of the main shell (e.g., 30), and the rough portion (e.g., 32) comprises a diagonal pattern, a grid pattern, or a predetermined symbol pattern.

16. The receptacle connector according to aspect 15 or any other aspect, wherein the predetermined symbol pattern comprises at least one of a starlike shape, an H shape, or an X shape.

17. The receptacle connector according to aspect 15 or any other aspect, wherein the rough portion (e.g., 32) has a width in a range of 0.1 mm to 5 mm from a mating edge of the main shell (e.g., 30) in the mating direction on an outer side wall of a mating end of the main shell (e.g., 30) extending beyond a mating end of the outer shell (e.g., 40).

18. The receptacle connector according to any one of aspects 1 to 6 or any other aspect, wherein the first sealing member (e.g., 50) is an elastically deformable member and the first sealing member (e.g., 50) is configured to elastically deform in when the first sealing member (e.g., 50) is in contact with the mounting portion of the electronic device, and to form an interference fit with the mounting portion of the electronic device in a direction perpendicular to the mating direction.

19. The receptacle connector according to any one of aspects 1 to 6 or any other aspect, wherein the first sealing member (e.g., 50) is configured to have an annular shape extending circumferentially and continuously around the mating end of the main shell (e.g., 30), and the first sealing member (e.g., 50) is configured to have an attachment surface forming a positive fit with the mating end of the main shell (e.g., 30).

20. The receptacle connector according to any one of aspects 1 to 6 or any other aspect, wherein the first sealing member (e.g., 50) is provided with a tapering portion (e.g., 51) tapering along the mating direction towards the mating end of the first sealing member (e.g., 50), and an inclined outer surface of the tapering portion (e.g., 51) forms an angle of 20 degrees to 40 degrees relative to a mating end surface of the first sealing member (e.g., 50).

21. A receptacle connector (e.g., 1) comprising: a terminal assembly (e.g., 10) comprising a housing (e.g., 11) and a plurality of conductive elements (e.g., 13) held by the housing, each of the plurality of conductive elements comprising a mating end (e.g., 304), a tail end (e.g., 306), and an intermediate portion between the mating end and the tail end; a first shell (e.g., 20) disposed on a portion (e.g., 110) of the housing of the terminal assembly and conforming to surfaces of the portion of the housing of the terminal assembly; a second shell (e.g., 30) surrounding the terminal assembly and extending from the mating ends of the plurality of conductive elements at least to the portion of the housing of terminal assembly; and a weld (e.g., 102) joining the second shell to the first shell.

22. The receptacle connector of aspect 21 or any other aspect, wherein the first shell and the portion of the housing comprise complementary features configured to engage each other so as to retain the first shell to the portion of the housing.

23. The receptacle connector of aspect 22 or any other aspect, wherein the complementary features comprise an opening (e.g., 702) of the first shell and a protrusion (e.g., 704) of the portion of the housing disposed in the opening of the first shell.

24. The receptacle connector of aspect 23 or any other aspect, wherein the complementary features comprise a recess (e.g., 111, 113) of the portion of the housing and a beam (e.g., 22, 24, 26, 28) of the first shell extending into the recess of the portion of the housing.

25. The receptacle connector of aspect 21 or any other aspect, wherein the portion of the housing of the terminal assembly is a first portion of the housing of the terminal assembly; the housing of the terminal assembly comprises a second portion (e.g., 120) disposed outside the second shell; and the receptacle connector comprises a rear seal (e.g., 60) disposed in the second shell and between the first and second portions of the housing of the terminal assembly.

26. The receptacle connector of aspect 25 or any other aspect, wherein a mating end (e.g., 204) of the second shell comprises a portion (e.g., 32) that has a surface roughness higher than that of portions of the first shell; and the receptacle connector comprises a front seal (e.g., 50) attached to the portion of the mating end of the second shell.

27. The receptacle connector of aspect 25 or any other aspect, comprising a third shell (e.g., 40) disposed outside the second shell and comprising one or more openings (e.g., 202) aligned with the weld joining the second shell to the first shell.

28. The receptacle connector of aspect 27 or any other aspect, wherein the weld joining the second shell to the first shell is a first weld; and the connector comprises a second weld (e.g., 104) joining the third shell to the second shell.

29. The receptacle connector of aspect 27 or any other aspect, wherein the second portion of the housing of the terminal assembly and the third shell comprise complementary features configured to engage each other so as to reduce risk of relative movement therebetween.

30. The receptacle connector of aspect 29 or any other aspect, wherein the complementary features comprise a recess (e.g., 411) of the third shell and a protrusion (e.g., 121) of the second portion of the housing of the terminal assembly disposed in the recess of the third shell.

31. A receptacle connector (e.g., 1) comprising a main shell (e.g., 30) surrounding a cavity (e.g., 208) and comprising a mating end (e.g., 204) and a tail end (e.g., 208) opposite the mating end; a terminal assembly (e.g., 10) disposed in the cavity, the terminal assembly comprising a housing (e.g., 11) comprising a tongue (e.g., 302), a rear portion (e.g., 120) disposed outside the main shell and comprising a protrusion (e.g., 121), and an intermediate portion between the tongue and the rear portion, and a plurality of conductive elements (e.g., 13) held by the housing, each of the plurality of conductive elements comprising a mating end (e.g., 304) extending in a mating direction (e.g., Y direction) and held by the tongue of the housing, a tail end (e.g., 306) extending out of the rear portion of the housing; and an outer shell (e.g., 40) disposed outside the main shell and comprising a plurality of legs (e.g., 212) extending in a mounting direction (e.g., Z direction) perpendicular to the mating direction and a recess (e.g., 411) extending opposite to the mounting direction, wherein the protrusion of the rear portion of the housing of the terminal assembly is disposed in the recess of the outer shell.

32. The receptacle connector of aspect 31 or any other aspect, wherein the protrusion of the rear portion of the housing of the terminal assembly is elongated in the mounting direction.

33. The receptacle connector of aspect 31 or any other aspect, wherein the mating end of the main shell extends beyond a mating end (e.g., 210) of the outer shell and comprises a portion that has a surface roughness higher than that of portions of the main shell; and the receptacle connector comprises a front seal (e.g., 50) attached to the portion of the mating end of the main shell.

34. The receptacle connector of aspect 31 or any other aspect, wherein, for each of the plurality of conductive elements: the tail end comprises a mounting surface (e.g., 214) extending perpendicular to the mounting direction.

35. The receptacle connector of aspect 31 or any other aspect, wherein the housing of the terminal assembly comprises one or more bars (e.g., 130) connecting the intermediate portion and the rear portion; and the receptacle connector comprises a rear seal (e.g., 60) enclosing the one or more bars and portion of the plurality of conductive elements extending between the intermediate portion and the rear portion of the housing of the terminal assembly.

36. The receptacle connector of aspect 31 or any other aspect, comprising an inner shell (e.g., 20) at least partially enclosing a portion of the intermediate portion of the housing of the terminal assembly, wherein the outer shell comprises one or more openings (e.g., 202) aligned with the inner shell; and the inner shell is welded to the main shell at locations (e.g., 102) corresponding to the one or more openings of the outer shell.

37. A method of manufacturing a receptacle connector (e.g., 1), the method comprising: providing a terminal assembly (e.g., 10) comprising a plurality of conductive elements (e.g., 13) held by a housing (e.g., 11); disposing a first shell (e.g., 20) on a portion (e.g., 110) of the housing of the terminal assembly; inserting the terminal assembly into a second shell (e.g., 30) until the first shell disposed inside the second shell and engaging inner surfaces of the second shell; and disposing a third shell (e.g., 40) on the second shell comprising inserting a protrusion (e.g., 121) of the housing of the terminal assembly into a recess (e.g., 411) of the third shell.

38. The method of aspect 37 or any other aspect, wherein the third shell comprises one or more openings (e.g., 202); and the method comprises welding the second shell to the first shell through the one or more openings of the third shell.

39. The method of aspect 37 or any other aspect, comprising welding the third shell to the second shell.

40. The method of aspect 37 or any other aspect, wherein disposing the first shell on the portion of the housing of the terminal assembly comprises bending beams (e.g., 22, 24, 26, 28) of the first shell into respective recesses of the portion of the housing.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear”, “upper”, “lower”, “left”, “right”, “transverse direction”, “vertical direction”, “perpendicular”, “horizontal”, “top”, “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector comprising:
a terminal assembly comprising a housing and a plurality of conductive elements held by the housing, each of the plurality of conductive elements comprising a mating end, a tail end, and an intermediate portion between the mating end and the tail end;
a first shell disposed on a portion of the housing of the terminal assembly and conforming to surfaces of the portion of the housing of the terminal assembly;
a second shell surrounding the terminal assembly and extending from the mating ends of the plurality of conductive elements at least to the portion of the housing of terminal assembly; and
a weld joining the second shell to the first shell.

2. The receptacle connector of claim 1, wherein:
the first shell and the portion of the housing comprise complementary features configured to engage each other so as to retain the first shell to the portion of the housing.

3. The receptacle connector of claim 2, wherein:
the complementary features comprise an opening of the first shell and a protrusion of the portion of the housing disposed in the opening of the first shell.

4. The receptacle connector of claim 3, wherein:
the complementary features comprise a recess of the portion of the housing and a beam of the first shell extending into the recess of the portion of the housing.

5. The receptacle connector of claim 1, wherein:
the portion of the housing of the terminal assembly is a first portion of the housing of the terminal assembly;
the housing of the terminal assembly comprises a second portion disposed outside the second shell; and
the receptacle connector comprises a rear seal disposed in the second shell and between the first and second portions of the housing of the terminal assembly.

6. The receptacle connector of claim 5, wherein:
a mating end of the second shell comprises a portion that has a surface roughness higher than that of portions of the first shell; and
the receptacle connector comprises a front seal attached to the portion of the mating end of the second shell.

7. The receptacle connector of claim 5, comprising:
a third shell disposed outside the second shell and comprising one or more openings aligned with the weld joining the second shell to the first shell.

8. The receptacle connector of claim 7, wherein:
the weld joining the second shell to the first shell is a first weld; and
the connector comprises a second weld joining the third shell to the second shell.

9. The receptacle connector of claim 7, wherein:
the second portion of the housing of the terminal assembly and the third shell comprise complementary features configured to engage each other so as to reduce risk of relative movement therebetween.

10. The receptacle connector of claim 9, wherein:
the complementary features comprise a recess of the third shell and a protrusion of the second portion of the housing of the terminal assembly disposed in the recess of the third shell.

11. A receptacle connector comprising:
a main shell surrounding a cavity and comprising a mating end and a tail end opposite the mating end;
a terminal assembly disposed in the cavity, the terminal assembly comprising:
a housing comprising a tongue, a rear portion disposed outside the main shell and comprising a protrusion, and an intermediate portion between the tongue and the rear portion, and
a plurality of conductive elements held by the housing, each of the plurality of conductive elements comprising a mating end extending in a mating direction and held by the tongue of the housing, a tail end extending out of the rear portion of the housing; and
an outer shell disposed outside the main shell and comprising a plurality of legs extending in a mounting direction perpendicular to the mating direction and a recess extending opposite to the mounting direction, wherein the protrusion of the rear portion of the housing of the terminal assembly is disposed in the recess of the outer shell.

12. The receptacle connector of claim 11, wherein:
the protrusion of the rear portion of the housing of the terminal assembly is elongated in the mounting direction.

13. The receptacle connector of claim 11, wherein:
the mating end of the main shell extends beyond a mating end of the outer shell and comprises a portion that has a surface roughness higher than that of portions of the main shell; and
the receptacle connector comprises a front seal attached to the portion of the mating end of the main shell.

14. The receptacle connector of claim 11, wherein, for each of the plurality of conductive elements:
the tail end comprises a mounting surface extending perpendicular to the mounting direction.

15. The receptacle connector of claim 11, wherein:
the housing of the terminal assembly comprises one or more bars connecting the intermediate portion and the rear portion; and
the receptacle connector comprises a rear seal enclosing the one or more bars and portion of the plurality of conductive elements extending between the intermediate portion and the rear portion of the housing of the terminal assembly.

16. The receptacle connector of claim 11, comprising:
an inner shell at least partially enclosing a portion of the intermediate portion of the housing of the terminal assembly, wherein:
the outer shell comprises one or more openings aligned with the inner shell; and
the inner shell is welded to the main shell at locations corresponding to the one or more openings of the outer shell.

17. A method of manufacturing a receptacle connector, the method comprising:
providing a terminal assembly comprising a plurality of conductive elements held by a housing;
disposing a first shell on a portion of the housing of the terminal assembly;
inserting the terminal assembly into a second shell until the first shell disposed inside the second shell and engaging inner surfaces of the second shell; and
disposing a third shell on the second shell comprising inserting a protrusion of the housing of the terminal assembly into a recess of the third shell.

18. The method of claim 17, wherein:
the third shell comprises one or more openings; and
the method comprises:
welding the second shell to the first shell through the one or more openings of the third shell.

19. The method of claim 17, comprising:
welding the third shell to the second shell.

20. The method of claim 17, wherein disposing the first shell on the portion of the housing of the terminal assembly comprises:
bending beams of the first shell into respective recesses of the portion of the housing.
